(19) United States
(12) Patent Application Publication
(10) Pub. No.: US 2006/0158407 A1
(43) Pub. Date: Jul. 20, 2006

(54) LIQUID CRYSTAL DISPLAY DEVICE, DRIVING CIRCUIT AND DRIVING METHOD THEREOF

(76) Inventors: Hung-Shiang Chen, Taipei Hsien (TW); Juin-Ying Huang, Tao-Yuan City (TW)

Correspondence Address: NORTH AMERICA INTELLECTUAL PROPERTY CORPORATION, P.O. BOX 506, MERRIFIELD, VA, 22116, US

(21) Appl. No.: 10/905,693

(22) Filed: Jan. 17, 2005

(51) Int. Cl. G09G 3/36

(52) U.S. Cl. 345/87; 345/103

(57) ABSTRACT

A driving circuit for use in a liquid crystal display (LCD) device includes: a drive signal generator for supplying a gate low voltage (VGL) signal, wherein the voltage swing of the VGL signal is substantially zero; a drive signal modifier coupled to the drive signal generator for generating a modified drive signal according to the VGL signal, wherein the voltage swing of the modified drive signal is substantially not zero; and a gate driving circuit coupled to the drive signal modifier for driving a plurality of scan lines of the liquid crystal display device according to the modified drive signal.

### BACKGROUND OF INVENTION

1. Field of the Invention

The present invention relates to a liquid crystal display (LCD) device, and more particularly, to an LCD device, driving circuit and driving method thereof.

2. Description of the Prior Art

Liquid crystal display (LCD) devices are widely employed in various applications such as portable information electronics (e.g., laptop computers and personal digital assistants), home consumer electronics (e.g., LCD TVs), aerospace apparatus, and medical electronic devices due to their merits of light weight, low power consumption, and no radiation.

A conventional LCD device typically comprises an LCD panel having a plurality of data lines and a plurality of scan lines (or referred to as gate lines) arranged so as to cross one another; a power supply for supplying various drive voltages required for the LCD device, such as a gate high voltage (VGH), a gate low voltage (VGL), a common voltage (VCOM), a source driving voltage, etc.; a gate driving circuit for driving the plurality of scan lines; and a source driving circuit for driving the plurality of data lines. Typically, the gate driving circuit comprises a plurality of gate driver integrated circuits (gate driver ICs) for sequentially applying scan signals to the plurality of scan lines. The source driving circuit comprises a plurality of source driver integrated circuits (source driver ICs) for applying corresponding source driving voltage signals to the data lines.

In general, the plurality of gate driver ICs of the gate driving circuit are respectively mounted onto a plurality of tape carrier packages (TCP or referred to as gate TCPs) and are connected in series via signal lines formed on a printed circuit board (PCB, or referred to as gate PCB), which is connected to the gate TCPs. The plurality of source driver ICs of the source driving circuit are respectively mounted onto another plurality of tape carrier packages, referred to as source TCPs, and are connected in parallel via signal lines formed on another PCB, referred to as source PCB, which is connected to the source TCPs.

In practice, a wire-on-array (WOA) architecture is commonly employed in LCD devices in order to reduce the manufacturing cost. The WOA architecture mounts the signal lines used for transmitting driving voltages to the gate driver ICs onto the LCD panel by adopting a line-on-glass (LOG) method instead of forming the signal lines on the gate PCB. In addition, the WOA architecture generally mounts the plurality of gate driver ICs of the gate driving circuit onto the LCD panel by employing a chip-on-glass (COG) method. As a consequence, the necessity of the gate PCB is eliminated so that the WOA architecture is also referred to as gate PCB-less architecture.

FIG. 1 depicts an internal schematic diagram of an LCD device 100 adopting the WOA architecture according to the prior art. As shown, the LCD device 100 comprises an LCD panel 110; a source PCB 120; a plurality of source TCPs (such as 130A and 130B) connected between a first side of the LCD panel 110 and the source PCB 120; a plurality of source driver ICs (such as 140A and 140B) mounted respectively onto the source TCPs; a plurality of gate driver ICs (such as 150A and 150B) directly mounted onto a second side of the LCD panel 110 by adopting the COG method; and a power supply 160 for applying various voltages required by the LCD panel 110. In implementations, the gate driver ICs could be respectively mounted onto a plurality of gate TCPs connected to the second side of the LCD panel 110.

The LCD panel 110 typically comprises a lower substrate 112, an upper substrate (not shown) for supporting color filters, and an LCD layer (not shown) sandwiched between the lower substrate 112 and the upper substrate. The lower substrate 112 is also referred to as thin film transistor (TFT) substrate (or array substrate) where a plurality of data lines 11 and a plurality of scan lines 12 are formed crossing one another. The plurality of data lines 11 are respectively coupled to the corresponding source driver ICs while the plurality of scan lines 12 are respectively coupled to the corresponding gate driver ICs. As shown in FIG. 1, the source driver ICs 140A and 140B receive the source driving voltages generated from the power supply 160 via a source BUS 22 formed on the source PCB 120. The gate driver ICs 150A and 150B receive gate driving voltages generated from the power supply 160 via the source PCB 120, the first source TCP 130A and a gate BUS 24 mounted onto the lower substrate 112 by adopting the LOG method.

FIG. 2 illustrates an equivalent circuit diagram of a single pixel unit 200 of the LCD panel 110. As shown in FIG. 2, the pixel unit 200 comprises a thin film transistor (TFT) 210 electrically connected between a scan line 12 and a data line 11; a liquid crystal cell, which is electrically equivalent to an LC capacitor CLC; and a storage capacitor CST. In addition, the pixel unit 200 further has a parasitic capacitor CGs between the data line 11 and the scan line 12. Accordingly, the transition of the source driving voltage signal applied on the data line 11 results in a capacitor coupling effect. In other words, the signal applied on the data line 11 is coupled to the scan line 12 through the parasitic capacitor CGs and therefore induces a return current feed through to a corresponding gate driver IC. Since the line resistance of the LOG type gate BUS 24 is much greater than the line resistance of the signal line formed on the PCB, the feed through voltages applied to the plurality of gate driver ICs differ from each other. Consequently, the input gate low voltage (VGL) signal varies from one gate driver IC to the next gate driver IC.

FIG. 3 illustrates a relationship between the source driving voltage signal and the VGL signal in accordance with the prior art. In FIG. 3, a signal 310 denotes an ideal VGL signal provided by the power supply 160. As shown, the voltage swing of the ideal VGL signal is substantially zero. When the logic level of a source driving voltage signal 330 applied on the data line 11 changes, the gate driver IC 150A is affected by the aforementioned capacitor coupling effect, so that many spurs (such as 322, 324, 326 and 328) occur in a VGL signal 320 outputted from the gate driver IC 150A. The VGL signal 320 outputted from the gate driver IC 150A is then transmitted into the next stage gate driver IC 150B. As shown in FIG. 3, there is an obvious voltage gap h between the VGL signals applied to the gate driver IC 150A and the gate driver IC 150B. As a result, “Block Mura” appears in the LCD panel 110, i.e., differences in brightness between different horizontal blocks exist, and thereby deteriorate the image quality of the LCD panel 110.

In US Patent Application Publication NO. 2004/0145552 “LIQUID CRYSTAL DISPLAY DEVICE AND DRIVING METHOD THEREOF” Song et al. disclosed a solution to prevent the aforementioned Block Mura phenomenon. In the disclosed driving method, a high resistance signal-limiting element (such as a high resistance resistor) is positioned on the gate BUS 24 before the gate BUS 24 connects to the first gate driver IC to limit the amount of current applied on the gate BUS 24. According to the disclosure, if the resistance of the signal-limiting element is much greater than the total resistance of the gate BUS 24, the influence of the resistance of the gate BUS 24 on the respective gate driver ICs may be substantially negligible. Consequently, substantially the same gate drive signal may be applied to the gate BUS 24 through each gate driver IC and the difference in brightness between horizontal blocks of the LCD panel 110 can be prevented.

However, the resistance of the signal-limiting element is typically as high as hundreds of ohms. Therefore, it requires more power consumption and generates more undesirable heat, which may cause a negative effect on the lifespan of the LCD device.

### SUMMARY OF INVENTION

It is therefore an objective of the claimed invention to provide a driving method for use in a liquid crystal display device to solve the above-mentioned problems.

According to an exemplary embodiment of the present invention, a driving circuit of a liquid crystal display device is disclosed comprising: a drive signal generator for supplying a gate low voltage (VGL) signal, wherein the voltage swing of the VGL signal is substantially zero; a drive signal modifier coupled to the drive signal generator for generating a modified drive signal according to the VGL signal, wherein the voltage swing of the modified drive signal is substantially not zero; and a gate driving circuit coupled to the drive signal modifier for driving a plurality of scan lines of the liquid crystal display device according to the modified drive signal.

According to the exemplary embodiment of the present invention, a method for driving a liquid crystal display (LCD) device is disclosed comprising: providing a gate low voltage (VGL) signal, wherein the voltage swing of the VGL signal is substantially zero; generating a modified drive signal according to the VGL signal, wherein the voltage swing of the modified drive signal is substantially not zero; and driving a plurality of scan lines of the LCD device according to the modified drive signal.

According to the exemplary embodiment of the present invention, an LCD device is further disclosed comprising: an LCD panel comprising a plurality of data lines and a plurality of scan lines arranged so as to cross one another; a drive signal generator for supplying a gate low voltage (VGL) signal, wherein the voltage swing of the VGL signal is substantially zero; a drive signal modifier coupled to the drive signal generator for generating a modified drive signal according to the VGL signal, wherein the voltage swing of the modified drive signal is substantially not zero; a gate driving circuit coupled to the drive signal modifier for driving the plurality of scan lines according to the modified drive signal; and a source driving circuit coupled to the drive signal generator for driving the plurality of data lines.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is an internal schematic diagram of an LCD device adopting the WOA architecture according to the prior art.

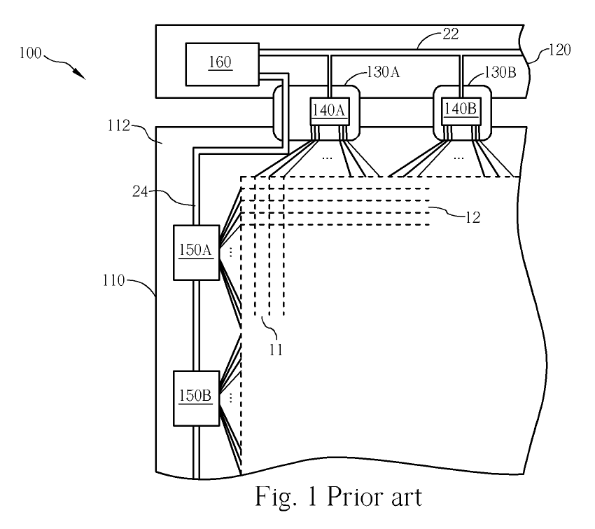

FIG. 2 is an equivalent circuit diagram of a single pixel unit of the LCD panel of FIG. 1.

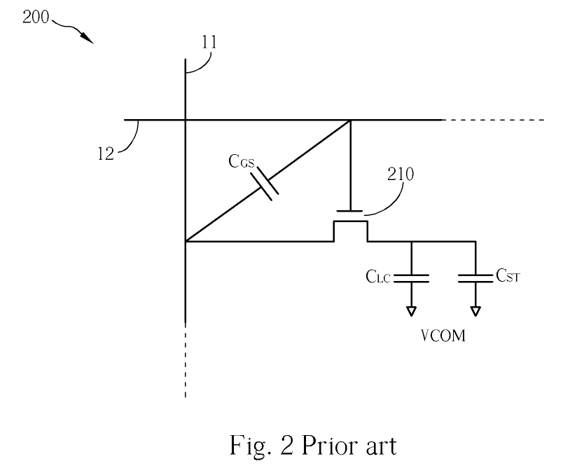

FIG. 3 is a relationship between a source driving voltage signal and a VGL signal in accordance with the prior art.

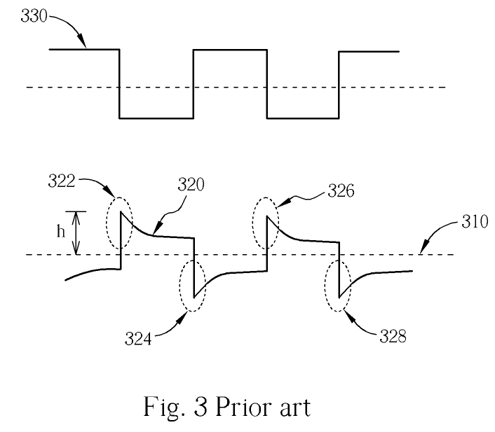

FIG. 4 is an internal schematic diagram of an LCD device according to an exemplary embodiment of the present invention.

FIG. 5 is a schematic diagram of a drive signal modifier of FIG. 4 according to an exemplary embodiment of the present invention.

FIG. 6 illustrates the influence of a parasitic capacitor effect on a modified gate low voltage signal generated from the drive signal modifier of FIG. 5 in accordance with the present invention.

### DETAILED DESCRIPTION

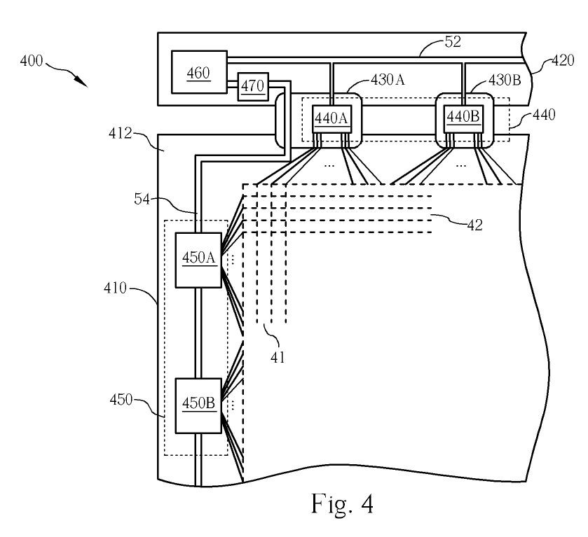

Please refer to FIG. 4, which depicts an internal schematic diagram of an LCD device 400 according to an exemplary embodiment of the present invention. The LCD device 400 comprises an LCD panel 410, a source PCB 420, a plurality of source TCPs (such as 430A and 430B) connected between a first side of the LCD panel 410 and the source PCB 420, a source driving circuit 440, a gate driving circuit 450, a drive signal generator 460, and a drive signal modifier 470 electrically connected between the drive signal generator 460 and the gate driving circuit 450.

In practical applications, the source driving circuit 440 generally comprises a plurality of source driver ICs (such as 440A and 440B) respectively mounted onto the plurality of source TCPs. The gate driving circuit 450 generally comprises a plurality of gate driver ICs (such as 450A and 450B) directly mounted onto a second side of the LCD panel 410 by adopting the COG technique. In implementations, the plurality of gate driver ICs of the gate driving circuit 450 could be respectively mounted onto a plurality of gate TCPs, which are connected to the second side of the LCD panel 410. As shown in FIG. 4, the LCD panel 410 typically comprises a lower substrate 412, an upper substrate (not shown) for supporting color filters, and an LCD layer (not shown) sandwiched between the lower substrate 412 and the upper substrate. As mentioned above, the lower substrate 412 is also referred to as TFT substrate or array substrate where a plurality of data lines 41 and a plurality of scan lines 42 are formed to cross one another. The plurality of data lines 41 are respectively coupled to the corresponding source driver ICs while the plurality of scan lines 42 are respectively coupled to the corresponding gate driver ICs.

In this embodiment, the drive signal generator 460 is used for generating various driving voltage signals required by the LCD panel 410, such as a gate high voltage (VGH) signal, a gate low voltage (VGL) signal, a common voltage (VCOM) signal, a source driving voltage signal, a ground voltage (GND) signal, etc. As is well known in the art, the voltage swing of the VGL signal provided by the drive signal generator 460 is substantially zero. Generally, the drive signal generator 460 could be implemented with a power supply but the present invention is not limited to this embodiment. As shown in FIG. 4, the source driving voltage generated from the drive signal generator 460 is transmitted to respective source driver ICs via a source BUS 52 formed on the source PCB 420.

The drive signal modifier 470 of this embodiment is used for generating a modified drive signal, which is hereinafter referred to as modified gate low voltage (MVGL) signal, according to the VGL signal supplied by the drive signal generator 460, wherein the voltage swing of the MVGL signal is substantially not zero. Specifically, the drive signal modifier 470 adjusts the voltage level of the VGL signal to produce the MVGL signal. Note that the MVGL signal is used for driving the gate driving circuit 450 instead of the VGL signal generated from the drive signal generator 460.

As shown in FIG. 4, the MVGL signal generated from the drive signal modifier 470 is transmitted to the gate driving circuit 450 via the first source TCP 430A and a gate BUS 54, which is mounted onto the lower substrate 412 using the LOG technique. In this embodiment, each of the plurality of gate driver ICs of the gate driving circuit 450 sequentially delivers the MVGL signal to the next stage gate driver IC so as to drive the scan lines according to the MVGL signal. In circuit designs, the drive signal modifier 470 could be configured on either the source PCB 420 or the first source TCP 430A, or directly mounted onto the lower substrate 412 by using the COG technique.

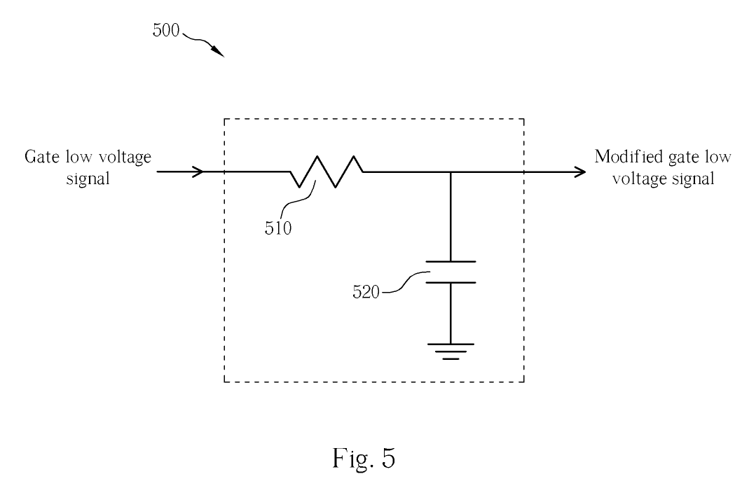

In practice, the drive signal modifier 470 could be implemented with analog techniques or digital techniques. For example, the drive signal modifier 470 could be implemented with an RC network as shown in FIG. 5. In the exemplary embodiment shown in FIG. 5, the RC network 500 comprises a resistor unit 510 and a capacitor unit 520. A first terminal of the resistor unit 510 is coupled to the VGL signal outputted from the drive signal generator 460 while a second terminal of the resistor unit 510 is coupled to the first gate driver IC 450 A of the gate driving circuit 450. The capacitor unit 520 has two terminals, wherein one terminal is coupled to the ground voltage while another terminal is coupled to the second terminal of resistor unit 510. In this embodiment, the RC network 500 acts as an RC oscillator and produces an oscillator signal, which is employed to be the MVGL signal.

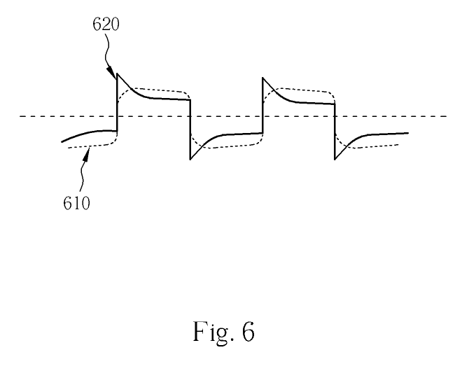

FIG. 6 illustrates the influence of the parasitic capacitor effect on the modified gate low voltage (MVGL) signal generated from the drive signal modifier 470 in accordance with the present invention. In FIG. 6, a signal 610 denotes an MVGL signal input to the first gate driver IC 450A from the drive signal modifier 470 while a signal 620 represents an MVGL signal output from the first gate driver IC 450A affected by the aforementioned parasitic capacitor effect. Obviously, the difference between the MVGL signal 610 input to the gate driver IC 450A and the MVGL signal 620 output from the gate driver IC 450A, which is also the input MVGL signal of the next stage gate driver IC 450B, is significantly reduced. In this way, the influence of the parasitic capacitor effect on the MVGL signals applied to respective gate driver ICs of the gate driving circuit 450 is greatly reduced. Consequently, the Block Mura phenomenon of the LCD panel 410 can be effectively prevented and the image quality of the LCD panel 410 is thereby greatly improved.

As mentioned above, the drive signal modifier 470 could be implemented with digital techniques. For example, the LCD device 400 can utilize a digital detector to detect an edge of the output signal of the source driving circuit 440 and alternatively adjust the voltage level of the VGL signal generated from the drive signal generator 460 when the edge occurs. As a result, the VGL signal is switched between two voltage levels so as to accomplish substantially the same function as the RC network 500. In practice, any other digital circuits capable of realizing the function of the drive signal modifier 470 should also be included in the embodiment of the present invention.

In the aforementioned descriptions, the drive signal modifier 470 with simple architecture is employed to modify the VGL signal provided by the drive signal generator 460 so as to reduce the influence of the parasitic capacitor effect on the drive signal (i.e., the MVGL signal) applied on respective gate driver ICs. Therefore, the Block Mura of the LCD panel 410 can be solved according to the present invention without changing the main manufacturing process of the LCD device 400 so that the required cost is quite limited.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving circuit of a liquid crystal display device comprising:
a drive signal generator for supplying a gate low voltage (VGL) signal, wherein the voltage swing of the VGL signal is substantially zero;
a drive signal modifier coupled to the drive signal generator for generating a modified drive signal according to the VGL signal, wherein the voltage swing of the modified drive signal is substantially not zero; and
a gate driving circuit coupled to the drive signal modifier for driving a plurality of scan lines of the liquid crystal display device according to the modified drive signal.

2. The driving circuit of claim 1, wherein the drive signal generator is a power supply.

3. The driving circuit of claim 1, wherein the drive signal modifier adjusts the voltage level of the VGL signal to generate the modified drive signal.

4. The driving circuit of claim 3, further comprising a source driving circuit coupled to the drive signal generator for driving a plurality of data lines of the LCD device;
wherein the drive signal modifier adjusts the voltage level of the VGL signal according to the output signal of the source driving circuit.

5. The driving circuit of claim 3, wherein the drive signal modifier is a RC network.

6. The driving circuit of claim 3, wherein the drive signal modifier comprises:
a resistor unit having first and second terminals, the first terminal coupled to the VGL signal while the second terminal is coupled to the gate driving circuit; and
a capacitor unit having two terminals, one terminal coupled to a ground voltage while another terminal is coupled to the second terminal of the resistor unit.

7. The driving circuit of claim 1, wherein the modified drive signal is transmitted to the gate driving circuit through a line-on-glass (LOG) signal line.

8. A liquid crystal display (LCD) device comprising:
an LCD panel comprising a plurality of data lines and a plurality of scan lines arranged so as to cross one another;
a drive signal generator for supplying a gate low voltage (VGL) signal, wherein the voltage swing of the VGL signal is substantially zero;
a drive signal modifier coupled to the drive signal generator for generating a modified drive signal according to the VGL signal, wherein the voltage swing of the modified drive signal is substantially not zero;
a gate driving circuit coupled to the drive signal modifier for driving the plurality of scan lines according to the modified drive signal; and
a source driving circuit coupled to the drive signal generator for driving the plurality of data lines.

9. The LCD device of claim 8, wherein the gate driving circuit is mounted onto the LCD panel in a chip-on-glass (COG) method.

10. The LCD device of claim 8, further comprising:
a printed circuit board (PCB);
wherein the drive signal generator is installed on the PCB.

11. The LCD device of claim 10, further comprising:
a tape carrier package (TCP) connected between the PCB and the LCD panel for supporting the source driving circuit.

12. The LCD device of claim 8, wherein the drive signal generator is a power supply.

13. The LCD device of claim 8, wherein the drive signal modifier adjusts the voltage level of the VGL signal to generate the modified drive signal.

14. The LCD device of claim 13, wherein the drive signal modifier adjusts the voltage level of the VGL signal according to the output signal of the source driving circuit.

15. The LCD device of claim 13, wherein the drive signal modifier is a RC network.

16. The LCD device of claim 13, wherein the drive signal modifier comprises:
a resistor unit having first and second terminals, the first terminal coupled to the VGL signal while the second terminal is coupled to the gate driving circuit; and
a capacitor unit having two terminals, one terminal coupled to a ground voltage while another terminal is coupled to the second terminal of the resistor unit.

17. A method for driving a liquid crystal display (LCD) device comprising:
providing a gate low voltage (VGL) signal, wherein the voltage swing of the VGL signal is substantially zero;
generating a modified drive signal according to the VGL signal, wherein the voltage swing of the modified drive signal is substantially not zero; and
driving a plurality of scan lines of the LCD device according to the modified drive signal.

18. The method of claim 17, wherein the step of generating the modified drive signal further comprises:
adjusting the voltage level of the VGL signal to generate the modified drive signal.

19. The method of claim 18, wherein the LCD device comprises a source driving circuit for driving a plurality of data lines of the LCD device, and the step of generating the modified drive signal further comprises:
adjusting the voltage level of the VGL signal according to the output signal of the source driving circuit.

20. The method of claim 17, further comprising:
utilizing an RC network to adjust the voltage level of the VGL signal.
